(19) United States
(12) Patent Application Publication
(10) Pub. No.: US 2023/0005004 A1
(43) Pub. Date: Jan. 5, 2023

(54) SYSTEMS AND METHODS FOR INCENTIVIZING SHARING OF TRANSACTION INFORMATION

(71) Applicant: FRUITI Partnership, London (GB)

(72) Inventors: Ala Anvari, London (GB); Shirin Abdollahyan, London (GB); Paul Quinn, Buckinghamshire (GB)

(21) Appl. No.: 17/364,700

(22) Filed: Jun. 30, 2021

(51) Int. Cl. G06Q 30/02; G06Q 40/02; G06Q 20/38; G06F 16/27; G06N 5/04

(52) U.S. Cl. CPC G06Q 30/0215; G06Q 40/02; G06Q 30/0201; G06Q 30/0202; G06Q 20/389; G06F 16/27; G06N 5/04

(57) ABSTRACT

The disclosed computer-implemented method for incentivizing sharing of transaction information may include receiving transaction data of a transaction between a user and a merchant. A portion of a transaction amount may be reserved. The method may include receiving the reserved portion for adding to a fund and aggregating the transaction data with collected transaction data from a plurality of users. The method may further include providing the aggregated transaction data. Various other methods, systems, and computer-readable media are also disclosed.

### BACKGROUND

Rounding-up or “penny-saving” schemes often allow consumers to add a small monetary value to a purchase price of a transaction. This small monetary value often rounds up the purchase price to the nearest dollar (or other currency denomination), may add several cents (e.g., pennies), or may otherwise amount to a small fraction of the purchase price. Rather than going towards the actual purchase transaction, the added amount may be directed to another purpose, such as a donation to a charity.

In addition, the retail transactions themselves may provide various useful data points. For example, the types of products purchased, frequency and timing of purchases, etc., may reveal certain consumer trends. Such consumer trends may be useful for investment decisions. However, many consumers may not wish to volunteer information about their retail transactions.

The instant disclosure, therefore, identifies and addresses a need for systems and methods for incentivizing sharing of transaction information.

### SUMMARY

As will be described in greater detail below, the instant disclosure describes various systems and methods for incentivizing sharing of transaction information.

In one example, a method for incentivizing sharing of transaction information may include (1) receiving transaction data of a transaction between a user and a merchant, wherein a portion of a transaction amount is reserved, (2) receiving the reserved portion for adding to a fund, (3) aggregating the transaction data with collected transaction data from a plurality of users, and (4) providing the aggregated transaction data.

In some examples, the method may further include associating the reserved portion with the user. In some examples, the method may further include calculating a dividend of the fund to distribute to the user based on the reserved portion. In some examples, the method may further include distributing the dividend to the user on a periodic basis. In some examples, the method may further include distributing the dividend to the user in response to a trigger condition.

In some examples, aggregating the transaction data may occur periodically. In some examples, aggregating the transaction data may occur monthly. In some examples, aggregating the transaction data may occur in response to a trigger condition. In some examples, aggregating the transaction data with collected data may include recording the aggregated transaction data on a distributed ledger.

In some examples, the method may further include: identifying at least one transaction characteristic from the aggregated transaction data and analyzing the aggregated transaction data for the at least one transaction characteristic. In some examples, the method of may further include providing results of the analysis. In some examples, the method the analysis may include statistical analysis for the at least one transaction characteristic. In some examples, the analysis may include predictive analysis for the at least one transaction characteristic. In some examples, the at least one transaction characteristic may include at least one of a merchant characteristic, an anonymized user characteristic, the transaction amount, a transaction timestamp, a transaction product, or a transaction mechanism.

In one embodiment, a system for incentivizing sharing of transaction information may include several modules stored in memory, including a transaction module, stored in memory, configured to receive transaction data of a transaction between a user and a merchant, wherein a portion of a transaction amount is reserved, a fund module, stored in memory, configured to receive the reserved portion for adding to a fund, an analysis module, stored in memory, configured to aggregate the transaction data with collected transaction data from a plurality of users, a data module, stored in memory, configured to provide the aggregated transaction data, and at least one physical processor that executes the transaction module, the fund module, the analysis module, and the data module.

In some examples, the fund module may further configured to: associate the reserved portion with the user, calculate a dividend of the fund to distribute to the user based on the reserved portion, and distribute the dividend to the user on a periodic basis.

In some examples, the analysis module may be further configured to: identify at least one transaction characteristic from the aggregated transaction data, wherein the at least one transaction characteristic comprises at least one of a merchant characteristic, an anonymized user characteristic, the transaction amount, a transaction timestamp, or a transaction product, and analyze the aggregated transaction data for the at least one transaction characteristic. In some examples, the data module may be further configured to provide results of the analysis.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (1) receive transaction data of a transaction between a user and a merchant, wherein a portion of a transaction amount is reserved, (2) receive the reserved portion for adding to a fund, (3) aggregate the transaction data with collected transaction data from a plurality of users, and (4) provide the aggregated transaction data.

In some examples, the non-transitory computer-readable medium may further include instructions for: associating the reserved portion with the user, calculating a dividend of the fund to distribute to the user based on the reserved portion, and distributing the dividend to the user on a periodic basis.

In some examples, the non-transitory computer-readable medium may further include instructions for: identifying at least one transaction characteristic from the aggregated transaction data, analyzing the aggregated transaction data for the at least one transaction characteristic, and providing results of the analysis.

In some examples, the analysis may include statistical analysis for the at least one transaction characteristic. In some examples, the analysis may include predictive analysis for the at least one transaction characteristic. In some examples, the at least one transaction characteristic may include at least one of a merchant characteristic, an anonymized user characteristic, the transaction amount, a transaction timestamp, a transaction product, or a transaction mechanism.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for incentivizing sharing of transaction information.

FIG. 2 is a block diagram of an additional example system for incentivizing sharing of transaction information.

FIG. 3 is a flow diagram of an example method for incentivizing sharing of transaction information.

FIG. 4 is a block diagram of an example computing system capable of implementing one or more of the embodiments described and/or illustrated herein.

FIG. 5 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for incentivizing sharing of transaction information. As will be explained in greater detail below, by receiving transaction data of a transaction, a portion of which is reserved, receiving the reserved portion for adding to a fund, aggregating the transaction data with collected transaction data, and providing the aggregated transaction data, the systems and methods described herein may facilitate receiving transaction data for analysis as well as facilitate transferring the reserved portion to the fund. By receiving the reserved portion and the transaction data in this way, the systems and methods described herein may be able to improve the collection of data to further improve analysis.

In addition, the systems and methods described herein may improve the functioning of a computing device by reducing network communications and overhead required for collecting data and transferring funds. These systems and methods may also improve the field of financial data analysis by simplifying the collection of data as well as facilitating collection of granular transaction data in near real-time.

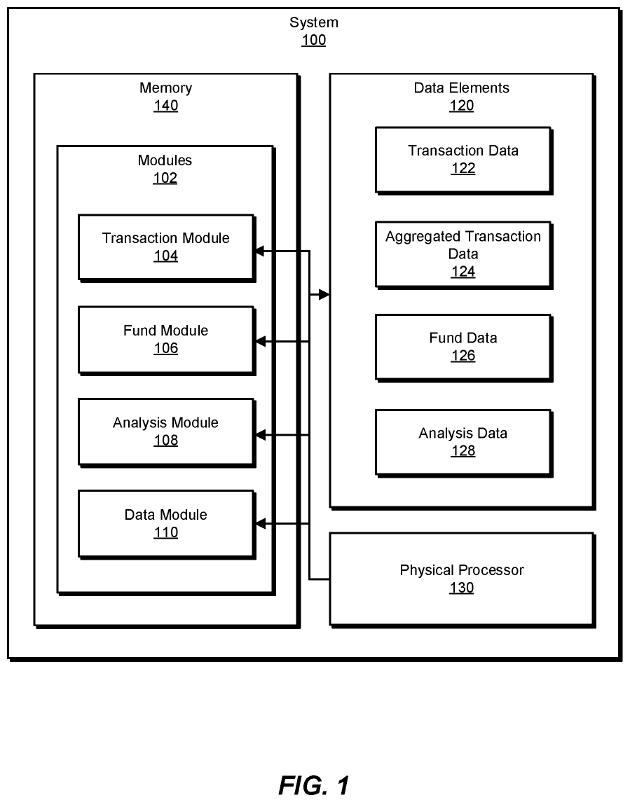

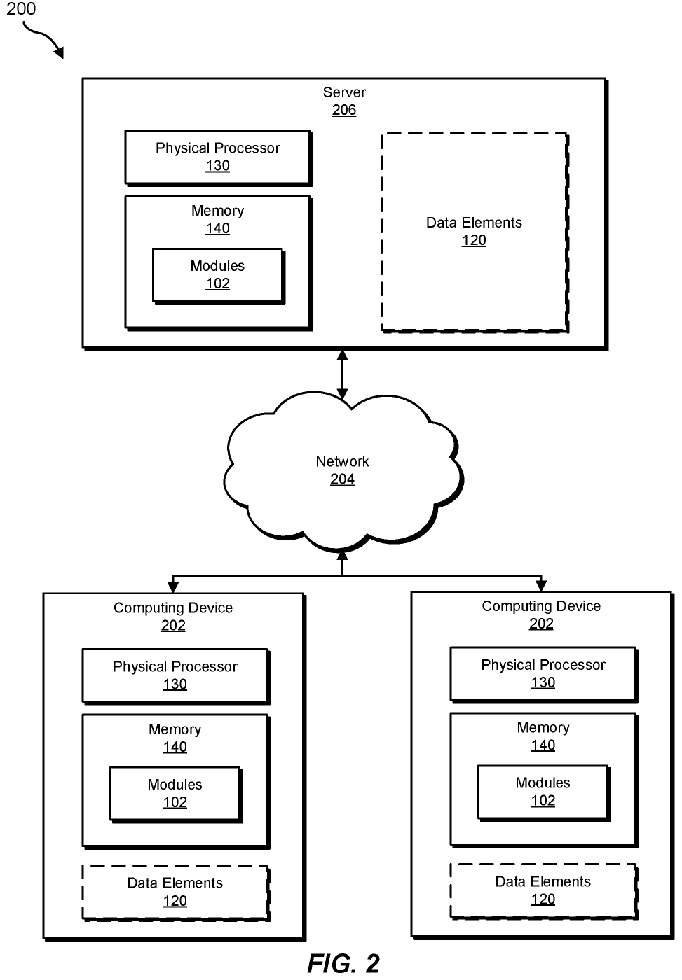

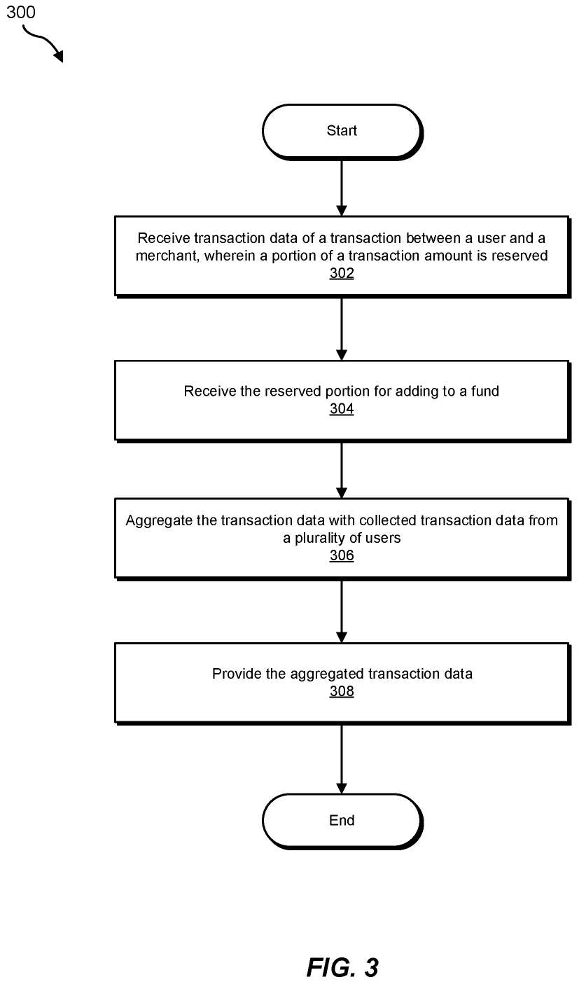

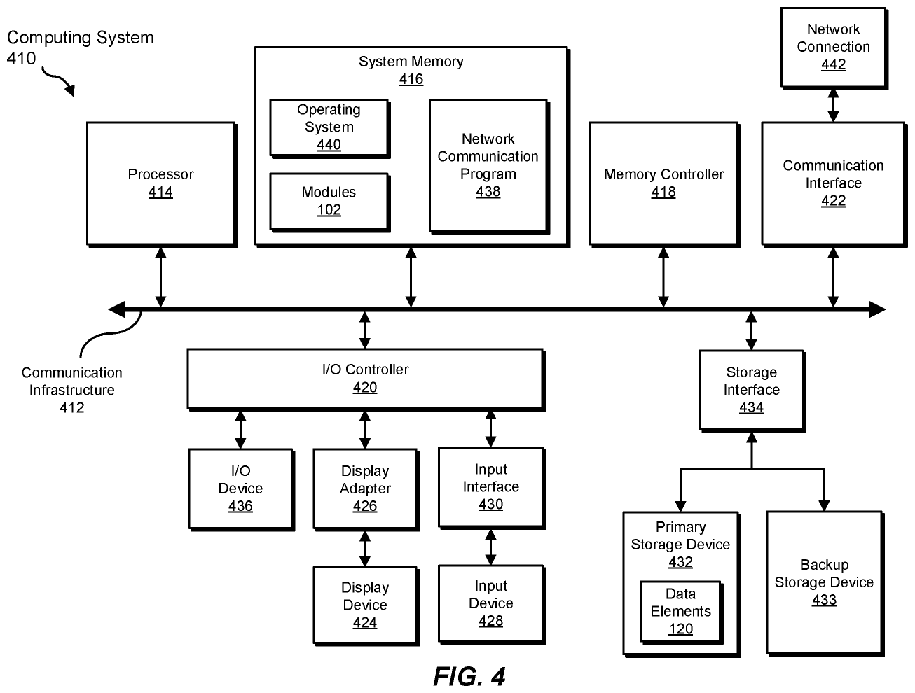

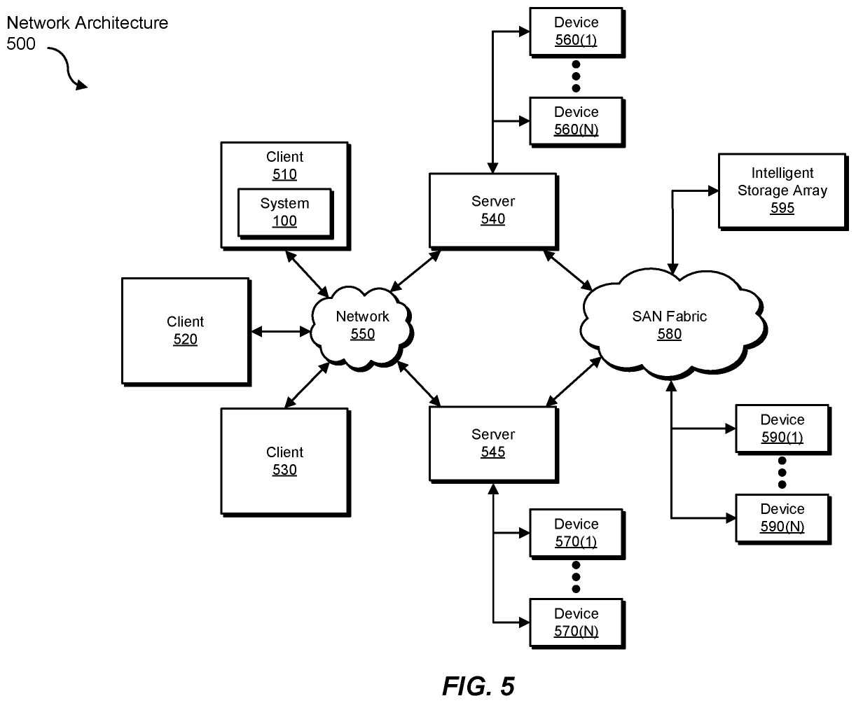

The following will provide, with reference to FIGS. 1-2, detailed descriptions of example systems for incentivizing sharing of transaction information. Detailed descriptions of corresponding computer-implemented methods will also be provided in connection with FIG. 3. In addition, detailed descriptions of an example computing system and network architecture capable of implementing one or more of the embodiments described herein will be provided in connection with FIGS. 4 and 5, respectively.

FIG. 1 is a block diagram of an example system 100 for incentivizing sharing of transaction information. As illustrated in this figure, example system 100 may include one or more modules 102 for performing one or more tasks. As will be explained in greater detail below, modules 102 may include a transaction module 104, a fund module 106, an analysis module 108, and a data module 110. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks. One or more of modules 102 in FIG. 1 may run concurrently, including multiple instances of one or more of modules 102. In some examples, one or more of modules 102 may further log system events and/or provide a decision support module.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate incentivizing sharing of transaction information. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include one or more data elements 120, such as transaction data 122, aggregated transaction data 124, fund data 126, and analysis data 128. Data elements 120 generally represent any type or form of data and/or metadata that may be generated, transformed, output, etc. As will be described further herein, transaction data 122 may correspond to granular data related to one or more transactions. Aggregated transaction data 124 may correspond to transaction data (e.g., various prior iterations of transaction data 122) that has been collected and, in some examples, analyzed. Fund data 126 may correspond to data relating to management of a fund, such as associated users, percentage of ownership, disbursement methodologies, etc. Analysis data 128 may correspond to data resulting from analyzing aggregated transaction data 124, which may include transaction data 122, and/or fund data 126. In some examples, one or more of data elements 120 (e.g., aggregated transaction data 124) may be stored or otherwise recorded in a distributed ledger or other data structure suitable for a decentralized computing system.

Example system 100 in FIG. 1 may be implemented in a variety of ways. For example, all or a portion of example system 100 may represent portions of example system 200 in FIG. 2. As shown in FIG. 2, system 200 may include one or more computing device 202 in communication with a server 206 via a network 204. In one example, all or a portion of the functionality of modules 102 may be performed by computing device 202, server 206, and/or any other suitable computing system. As will be described in greater detail below, one or more of modules 102 from FIG. 1 may, when executed by at least one processor of computing device 202 and/or server 206, enable computing device 202 and/or server 206 to incentivize sharing of transaction data. For example, and as will be described in greater detail below, one or more of modules 102 may cause computing device 202 and/or server 206 to recite steps of method claim using FIG. 2.

Computing device 202 generally represents any type or form of computing device capable of reading computer-executable instructions. Computing device 202 may be, for example, a point-of-sale (“POS”) computing device or computing device communicatively coupled to a POS device. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), payment terminals, variations or combinations of one or more of the same, and/or any other suitable computing device.

Server 206 generally represents any type or form of computing device that is capable of receiving, analyzing, and providing data. Server 206 may be a back-end server with restricted access, such as access restricted to a fund manager. Additional examples of server 206 include, without limitation, application servers, web servers, storage servers, database servers and/or security servers, configured to run certain software applications and/or provide various web, storage, database, and/or security services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network. In some examples, data transferred through network 204 may be encrypted or otherwise protected. In some examples, computing device 202 and/or server 206 may correspond to nodes of a distributed computing paradigm, such as edge computing. For example, computing device 202 and/or server 206 may correspond to a cloud server, an edge server, etc.

As illustrated in FIG. 2, data elements 120 and/or portions thereof, may be stored on server 206 and/or computing device 202, and may be transferred therebetween via network 204. In some examples, data elements 120 may be locally stored and/or transferred within a local network. In some examples, different portions of data elements 120 may be stored across multiple computing devices 202 such that server 206 may partially or fully aggregate data elements 120. For example, in a decentralized computing system or peer-to-peer (“P2P”) system, each computing device 202 may include local copies of one or more modules 102 along with locally relevant portions of data elements 120. Moreover, in such examples, server 206 may further manage certain functions, even with the P2P or decentralized system, to ensure fidelity across the various nodes. For instance, server 206 may, in addition to performing aggregation functions, manage user accounts and logins, may ensure that the various nodes follow protocols, propagate updates to software or code (e.g., one or more modules 102), interface with other third-party systems (e.g., banking systems), verify records (e.g., transactions written to ledgers), etc.

FIG. 3 is a flow diagram of an example computer-implemented method 300 for incentivizing sharing of transaction information. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may receive transaction data of a transaction between a user and a merchant, wherein a portion of a transaction amount is reserved. For example, transaction module 104 may, as part of computing device 202 in FIG. 2, receive transaction data 122 of a transaction between a user and a merchant.

Transaction data 122 may include data relating to various aspects of a transaction between the user and the merchant. In some examples, the user may be a person (e.g., a consumer, customer, etc.) conducting a transaction involving a financial exchange with the merchant. In some examples, the user may be an entity or other party (e.g., an agent for the person, a group of persons, an organization, etc.). In some examples, user data may include user accounts, user country, user financial details, user opt-ins, etc. In some examples, the merchant may be an entity or party (e.g., a retail business, an organization, a company, another user, an agent for a user, etc.) that may provide goods and/or services to the user in exchange for financial compensation reflected in the transaction amount (e.g., a single amount of money, one or more payments, etc.).

In some examples, the transaction may be a retail transaction, such as a purchase of goods and/or services. In other examples, the transaction may be any other type of transaction that may involve financial compensation. For example, the transaction may be a refund or other modification of a prior transaction. In such examples, some or all of transaction data 122 may be re-identified in order to match with the prior transaction.

In some examples, transaction data 122 may be anonymized so as to preserve the user's privacy. For example, certain analysis, particularly aggregated data analysis, may not access user-identifiable information. Anonymizing may include, for example, deidentification (e.g., removing, genericizing, and/or otherwise modifying identifying information such as names), stratification (e.g., classifying certain characteristics such as age into a range or other category), and/or masking (e.g., obfuscating a portion or all of identifying information such as names). In some examples, transaction data 122 may maintain certain data in order to properly associated the user with the reserved portion of the transaction amount, for instance to appropriately credit the user's allocation of the fund.

The user may have provided permission for the systems and services described herein to collect transaction data 122. In some examples, the user may have signed up for a service as described herein to collect the user's transaction data, including transaction data 122. In some examples, the user may provide permission to collect transaction data, such as transaction data 122, for each transaction during or after the transaction is completed. In some examples, the user may provide permission for collecting transaction data from one or more types or classes of transactions, such as transactions involving a particular merchant, a particular payment method (e.g., a credit card, financial institution, etc.), particular types of goods and/or services, or other criteria. In addition, the user may provide permission as to what aspects of the transaction data may be collected, for instance allowing or restricting collection of demographic information or other personally identifiable information in order to preserve the user's privacy. In some examples, transaction module 104 may collect transaction data 122 that may include only data that the user has allowed. In other examples, transaction module 104 may strip data from transaction data 122 to conform with the user's preferences. In some examples, the user may specify what types of analysis to perform, which data may be analyzed, etc. For example, the user may select between value-based analysis (e.g., high yield), privacy-based (e.g, sharing more data for more robust analysis). In some examples, the analysis performed by transaction module 104 may depend of what data is shared. For example, transaction module 104 may automatically select what types of analysis to perform based on which user opt-in data is shared by the user.

The transaction amount may refer to the actual financial compensation provided by the user to the merchant as part of the transaction for goods and/or services from the merchant. The transaction amount may refer to the entire financial compensation amount, including the reserved portion. The reserved portion may refer to a portion of the transaction amount to be reserved for a fund as described herein. The reserved portion may be a calculated portion (e.g., a percentage of the retail transaction amount between the user and the merchant, a rounded up amount such as an amount to bring the transaction amount to the nearest dollar or other denomination) or a fixed portion (e.g., a fixed dollar amount). In some examples, the user may designate the reserved portion, such as by designating a desired percent, rounding, custom fixed amount, etc., and the user may further designate the reserved portion (which may be a percentage and/or absolute a mount) for each transaction, class of transactions, or designate a default value to be used when the user does not specify for a particular transaction.

In one example, the user may be a consumer purchasing a good from a retailer, for instance, either online or in a brick and mortar store. The user may have previously provided permission for collecting transaction data relating to this transaction, using a round-up amount as the reserved portion.

In some examples, transaction data 122 may be further processed, either before and/or after step 302. For example, transaction data 122 may be anonymized as described herein. In addition, a master data lookup may retrieve additional data for enriching the transaction data for analysis based on stored lookup keys, metadata, or anonymized values.

In some examples, transaction data 122 may be recorded or otherwise stored in a distributed ledger. A distributed ledger may refer to digital data that may be replicated, shared, and synchronized across multiple nodes (e.g., computing devices), such as in a peer-to-peer network or other decentralized computing system. A consensus algorithm may ensure that the data is properly replicated across the nodes. In some examples, computing devices 202 in FIG. 2 may be nodes of a P2P or other decentralized system. In such examples, each computing device 202 may manage a particular ledger. For instance, computing device 202 associated with a user (e.g., a mobile device) may manage at least portions of transaction data 122 of transactions by the user in a distributed ledger. Computing device 202 associated with a merchant (e.g., a merchant POS device) may manage at least portions of transaction data 122 for the merchant in a distributed ledger. These distributed ledgers may be made available to other nodes (e.g., server 206) for aggregation, as described herein.

In some examples, when a merchant completes a transaction, for example on a POS device, the POS device may send transaction data 122 for the transaction to interested parties. For example, the users' computing device 202 and/or server 206 may subscribe to events from the POS device such that transaction events (or other events described herein) may be sent to the subscribed devices. Alternatively or additionally, the interested parties may poll the POS device periodically to received updated transaction data 122.

At step 304 one or more of the systems described herein may receive the reserved portion for adding to a fund. For example, fund module 106 may, as part of computing device 202 in FIG. 2, receive or otherwise facilitate transfer of the reserved portion for adding to a fund associated with fund module 106. Fund module 106 may track or otherwise record data on the transfer of the reserved portion in fund data 126.

In some examples, fund module 106 may directly facilitate transfer of the reserved portion. For example, fund module 106 may directly access the user's financial institution to transfer the reserved portion to the fund's financial institution. Alternatively, fund module 106 may directly access the merchant's financial institution to transfer the reserved portion (which may have been transferred from the user's financial institution to the merchant's financial institution) to the fund's financial institution. In such examples, receiving the reserved portion may include directly receiving the reserved portion into the fund.

In some examples, fund module 106 may indirectly facilitate transfer of the reserved portion. For example, fund module 106 may provide instructions to an agent permitted to access the user's and/or the merchant's financial institution to direct the reserved portion to the fund's financial institution. In such examples, receiving the reserved portion may include indirectly receiving the reserved portion, or receiving access to the reserved portion for redirecting into the fund.

In some examples, fund module 106 may further associate the reserved portion with the user. Fund module 106 may associate the reserved portion with the user by recording the reserved portion amount with a user ID, which may be anonymized but may allow identifying the appropriate user with the reserved portion. For instance, fund module 106 may record how much the user added to the fund in fund data 126. In some examples, such as in examples where transaction data 122 may be deidentified, portions of transaction data 122 may be re-identified in order to associate the reserved portion with the user. For instance, transaction data 122 may be associated with one or more keys for re-identification or otherwise reassociating transaction data 122 with the user. The keys may be securely stored remotely in order to preserve data privacy.

In some examples, fund module 106 may track how much the user has contributed to the fund. In some examples, fund module 106 may further calculate a dividend of the fund to distribute to the user based on the reserved portion. For example, fund module 106 may determine how much the user contributed to the fund (e.g., an aggregate amount of reserved portions provided by the user via transactions) and appropriately calculate the dividend, for instance based on percent of the total fund amount contributed by the user. Fund module 106 may calculate and/or distribute the dividend to the user on a periodic basis, such as monthly, yearly, etc. In some examples, fund module 106 may distribute the dividend to the user in response to a trigger condition. For example, fund module 106 may collect calculated dividends for the user and distribute the collected dividend when the collected dividend reaches a threshold amount. Other trigger conditions may include time-based conditions, transaction-based conditions (e.g., after n transactions, after a certain type of transaction is completed, etc.). Fund module 106 may have access or permission to transfer the dividend, although in other examples, fund module 106 may instruct an agent to do so. In some examples, the dividend may be a non-zero value, although in other examples the dividend may be zero, trivial, or otherwise nominal in value.

Fund module 106 may further manage and/or facilitate management of the fund. For example, fund module 106 may track how much capital the user invested into the fund (e.g., the combined amount of reserved portions from the user). If the user leaves the fund, fund module 106 may determine how much of the fund's current value is attributable to the user and disburse the appropriate amount. In some examples, the user may withdraw a portion of the user's capital, such as an amount specified by the user or as part of a refund of a prior transaction. Fund module 106 may facilitate withdrawal of the specified amount, or may facilitate withdrawal of a particular value (e.g., if the user wishes to withdraw the current value of a particular initial amount).

In some examples, fund module 106 may manage fund data 126 as a distributed ledger. For example, fund module 106 may attribute the reserved portion to the user as a record in the distributed ledger. In such examples, fund module 106 may operate as part of computing device 202 and fund data 126 may comprise a separate ledger than that of transaction data 122 or any other ledger described herein.

At step 306 one or more of the systems described herein may aggregate the transaction data with collected transaction data from a plurality of users. For example, analysis module 108 may, as part of computing device 202 in FIG. 2, aggregate transaction data 122 with aggregated transaction data 124 that may comprise collected transaction data from a plurality of users.

Analysis module 108 may aggregate aggregated transaction data 124 periodically, for instance monthly, yearly, weekly, etc. In some examples, analysis module 108 may aggregate aggregated transaction data 124 in response to one or more trigger conditions. For example, analysis module 108 may aggregate aggregated transaction data 124 after every n number of transactions have been recorded, after the associated fund (which may be reflected in fund data 126) has reached a threshold amount or milestone, in conjunction with any other event (e.g., any of the steps described herein), etc. In some examples, analysis module 108 may aggregate aggregated transaction data 124 based on a time window, such as portions of transaction data 122 that may fall within a specified date range. The time window may be the same for each iteration or may vary for each iteration, and may be determined automatically or manually set by an associated user, such as the user, a user with access to the associated fund, etc. In some examples, analysis module 108 may aggregate aggregated transaction data 124 in response to a user request from any associated user, such as the user, a user with access to the associated fund, etc.

Aggregated transaction data 124 may include transaction data (e.g., transaction data 122 once aggregated) of one or more transactions from one or more users. In some examples, aggregated transaction data 124 may include or otherwise incorporate data (which may have been anonymized as described herein) relating to all transactions recorded for all users associated with the given fund. In some examples, aggregated transaction data 124 may be limited to data relating to a subset of users. Aggregated transaction data 124 may be stored in a database or other data storage system.

To further leverage aggregated transaction data 124, analysis module 108 may analyze aggregated transaction data 124 to generate analysis data 128. In some examples, analysis module 108 may identify at least one transaction characteristic from aggregated transaction data 124. For example, the transaction characteristic may be one or more of: a merchant characteristic (e.g., type of merchant, category of goods and/or services provided by the merchant, corporate structure of the merchant, size of the merchant, location and/or agent of the merchant performing the transaction, marketing campaigns of the merchant associated with the transaction, promotions associated with the merchant, point-of-sale terminal characteristics, card terminal location, etc.), an anonymized user characteristic (e.g., demographic information, geographic information, method of performing the transaction, descriptions/comments/instructions regarding the transaction, etc.), the transaction amount (e.g., the retail transaction amount, the total transaction amount, the reserved portion, associated discounts for the transaction, etc.), a transaction timestamp (e.g., a time of the transaction, a time of day/week/month/year of the transaction, a season/holiday associated with the transaction, a time to complete the transaction, frequency of transactions, etc.), a transaction product (e.g., details and/or descriptions of the goods and/or services provided, category of transaction product, age of transaction product, etc.), and a transaction mechanism (e.g., payment terminal, payment intermediary, credit card number and/or bank routing information which may be anonymized, etc.). In some examples, the user may provide permission to perform aggregations and/or analysis on potentially identifying information such as user ID data.

Analysis module 108 may perform analysis on aggregated transaction data 124 for the transaction characteristic to generate analysis data 128. The analysis may include statistical analysis for the identified transaction characteristic(s), predictive analysis for the identified transaction characteristic(s) (e.g., a data prediction and/or prediction relating to one or more future transactions, etc.), prescriptive analytics, or any other analysis. Analysis module 108 may use machine learning or other artificial intelligence scheme to analyze aggregated transaction data 124 and generate analysis data 128.

Analysis data 128 may reveal trends, patterns, and/or other statistically significant features from aggregated transaction data. For example, analysis data 128 may indicate that at certain times of the year, users may increasingly purchase particular product categories. In another example, analysis data 128 may indicate that certain products may be consistently or increasingly purchased above or below their retail prices. Other trends revealed by analysis data 128 may include, without limitation, correlations between sales/advertising and purchases, spending habits of anonymized categories of consumers, times of day when certain products are purchased, etc. In yet another example, analysis data 128 may provide purchasing trends of particular retailers.

Analysis module 108 may be able to provide real-time or near real-time analysis of aggregated transaction data 124 such that analysis data 128 may reveal real-time or near real-time trends. In some examples, analysis module 108 may interface with fund module 106 such that fund module 106 may use analysis data 128, or portions thereof, to manage the fund. Fund module 106 may utilize various signals, such as trends revealed in analysis data 128, for investing some or all of the fund. Fund module 106 may be able to respond to real-time or near real-time analysis provided by analysis module 108.

Moreover, fund module 106 may provide or otherwise facilitate customized management of the fund. For example, the user, or a class of users, may wish for their portion of the fund to be invested in certain designated businesses/industries/entities, at certain specific times, in response to certain triggers, etc. The user may also wish for certain transactions and/or categories of transactions to be invested in certain ways. Fund module 106 may allow macro to granular management of the fund, as well as automated management of the fund. For example, based on the user's preferences, fund module 106 may invest reserved portions from specific transactions into specific commodities in response to analysis module 108 detecting a trend with respect to the commodities.

In some examples, analysis module 108 may operate as a part of server 206 in a P2P or decentralized system. For example, server 206 may access transaction data 122, which may be a distributed ledger maintained by computing device 202. Server 206 may further access fund data 126 to verify its records.

As illustrated in FIG. 3, at step 308 one or more of the systems described herein may provide the aggregated transaction data. For example, data module 110 may, as part of computing device 202 in FIG. 2, provide aggregated transaction data 124 for display on a computing device. In some examples, providing aggregated transaction data 124 may include providing the results of the analysis (e.g., analysis data 128). Alternatively, providing aggregated transaction data 124 may be indirect. Rather than providing aggregated transaction data 124, data module 110 may provide analysis data 128 instead.

Data module 110 may provide aggregated transaction data 124 and/or analysis data 128 to a user requesting such data, such as the user (e.g., the retail consumer), a fund user (e.g., a fund manager with access to the fund associated with fund data 126), and/or any other authorized user (e.g., retailer, consultant, etc.). In some examples, data module 110 may ensure that only authorized users may access such data, for instance by requiring verification/authentication of the requesting user, encrypting aggregated transaction data 124 and/or analysis data 128, and other security measures.

In some examples, data module 110 may format analysis data 128 and/or aggregated transaction data 124 for display. Data module 110 may facilitate transforming analysis data 128 and/or aggregated transaction data 124 for display, for input into another module (e.g., fund module 106 to enable fund module 106 to respond to analysis data 128 and/or aggregated transaction data 124 as described herein), etc. In some examples, data module 110 may, alone or in conjunction with another module such as fund module 106 and/or analysis module 108, determine certain aspects of analysis data 128 and/or aggregated transaction data 124 to be highlighted. For example, if analysis data 128 indicates a drastic or otherwise abnormal trend (e.g., satisfying certain predetermined and/or dynamic trigger conditions and/or thresholds, or if the trend runs counter to prior trends, represents a deviation, or other statistically significant deviation), data module 110 may prioritize the abnormal trend. Data module 110 may prioritize the abnormal trend by highlighting the related data (e.g., by making visually distinct, presenting first, etc.) and/or by sending specific notifications/alerts with respect to the abnormal trend.

In some examples, data module 110 may format analysis data 128 and/or aggregated transaction data 124 based on an intended recipient. For example, data module 110 may present, to the user or retailer, data directly associated with the user or retailer, respectively. Data module 110 may format the data for aggregated analysis to the fund manager. Formatting may include, for instance, modifying the data based on the intended recipient. For instance, data module 110 may limit how much deep analysis is provided to the user. In addition, based on an intended recipient, data module 110 may anonymize all or a portion of analysis data 128 and/or aggregated transaction data 124, such as appropriate for consumption by third parties.

As explained above in connection with example method 300 in FIG. 3, a retail transaction system may incentivize users to share transaction information by investing a small amount of the transaction into a fund. The systems and methods described herein may facilitate the collection of retail transaction data as well as transferring a reserved portion each transaction to an investment fund. The systems and methods described herein may periodic (e.g. calendar monthly, 30-day windows, quarterly, weekly, yearly, etc.) aggregate data of spending by members for retail companies to provide company specific aggregates as reports to the fund.

In some examples, a fund manager may use the reports to better manage the fund. The systems and methods described herein may facilitate tracking what each user has paid (e.g., via reserved portions) as capital invested, and use the capital invested amount to apportion proceeds from yearly dividends based on profits made by the fund each year. If a user leaves the fund, the user may receive back their accrued capital. If the fund hits below a performance threshold (e.g., the capital left is 80% of a nominal total invested amount), the user may be paid back a proportional fraction of their initial capital invested. However, in other examples, the fund may be managed in other ways and/or based on other schemes.

FIG. 4 is a block diagram of an example computing system 410 capable of implementing one or more of the embodiments described and/or illustrated herein. For example, all or a portion of computing system 410 may perform and/or be a means for performing, either alone or in combination with other elements, one or more of the steps described herein (such as one or more of the steps illustrated in FIG. 3). All or a portion of computing system 410 may also perform and/or be a means for performing any other steps, methods, or processes described and/or illustrated herein.

Computing system 410 broadly represents any single or multi-processor computing device or system capable of executing computer-readable instructions. Examples of computing system 410 include, without limitation, workstations, laptops, client-side terminals, servers, distributed computing systems, handheld devices, or any other computing system or device. In its most basic configuration, computing system 410 may include at least one processor 414 and a system memory 416.

Processor 414 generally represents any type or form of physical processing unit (e.g., a hardware-implemented central processing unit) capable of processing data or interpreting and executing instructions. In certain embodiments, processor 414 may receive instructions from a software application or module. These instructions may cause processor 414 to perform the functions of one or more of the example embodiments described and/or illustrated herein.

System memory 416 generally represents any type or form of volatile or non-volatile storage device or medium capable of storing data and/or other computer-readable instructions. Examples of system memory 416 include, without limitation, Random Access Memory (RAM), Read Only Memory (ROM), flash memory, or any other suitable memory device. Although not required, in certain embodiments computing system 410 may include both a volatile memory unit (such as, for example, system memory 416) and a non-volatile storage device (such as, for example, primary storage device 432, as described in detail below). In one example, one or more of modules 102 from FIG. 1 may be loaded into system memory 416.

In some examples, system memory 416 may store and/or load an operating system 440 for execution by processor 414. In one example, operating system 440 may include and/or represent software that manages computer hardware and software resources and/or provides common services to computer programs and/or applications on computing system 410. Examples of operating system 440 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 410 may also include one or more components or elements in addition to processor 414 and system memory 416. For example, as illustrated in FIG. 4, computing system 410 may include a memory controller 418, an Input/Output (I/O) controller 420, and a communication interface 422, each of which may be interconnected via a communication infrastructure 412. Communication infrastructure 412 generally represents any type or form of infrastructure capable of facilitating communication between one or more components of a computing device. Examples of communication infrastructure 412 include, without limitation, a communication bus (such as an Industry Standard Architecture (ISA), Peripheral Component Interconnect (PCI), PCI Express (PCIe), or similar bus) and a network.

Memory controller 418 generally represents any type or form of device capable of handling memory or data or controlling communication between one or more components of computing system 410. For example, in certain embodiments memory controller 418 may control communication between processor 414, system memory 416, and I/O controller 420 via communication infrastructure 412.

I/O controller 420 generally represents any type or form of module capable of coordinating and/or controlling the input and output functions of a computing device. For example, in certain embodiments I/O controller 420 may control or facilitate transfer of data between one or more elements of computing system 410, such as processor 414, system memory 416, communication interface 422, display adapter 426, input interface 430, and storage interface 434.

As illustrated in FIG. 4, computing system 410 may also include at least one display device 424 coupled to I/O controller 420 via a display adapter 426. Display device 424 generally represents any type or form of device capable of visually displaying information forwarded by display adapter 426. Similarly, display adapter 426 generally represents any type or form of device configured to forward graphics, text, and other data from communication infrastructure 412 (or from a frame buffer, as known in the art) for display on display device 424.

As illustrated in FIG. 4, example computing system 410 may also include at least one input device 428 coupled to I/O controller 420 via an input interface 430. Input device 428 generally represents any type or form of input device capable of providing input, either computer or human generated, to example computing system 410. Examples of input device 428 include, without limitation, a keyboard, a pointing device, a touchscreen, a speech recognition device, variations or combinations of one or more of the same, and/or any other input device.

Additionally or alternatively, example computing system 410 may include additional I/O devices. For example, example computing system 410 may include I/O device 436. In this example, I/O device 436 may include and/or represent a user interface that facilitates human interaction with computing system 410. Examples of I/O device 436 include, without limitation, a computer mouse, a keyboard, a monitor, a printer, a modem, a camera, a scanner, a microphone, a touchscreen device, variations or combinations of one or more of the same, and/or any other I/O device.

Communication interface 422 broadly represents any type or form of communication device or adapter capable of facilitating communication between example computing system 410 and one or more additional devices. For example, in certain embodiments communication interface 422 may facilitate communication between computing system 410 and a private or public network including additional computing systems. Examples of communication interface 422 include, without limitation, a wired network interface (such as a network interface card), a wireless network interface (such as a wireless network interface card), a modem, and any other suitable interface. In at least one embodiment, communication interface 422 may provide a direct connection to a remote server via a direct link to a network, such as the Internet. Communication interface 422 may also indirectly provide such a connection through, for example, a local area network (such as an Ethernet network), a personal area network, a telephone or cable network, a cellular telephone connection, a satellite data connection, or any other suitable connection.

In certain embodiments, communication interface 422 may also represent a host adapter configured to facilitate communication between computing system 410 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 422 may also allow computing system 410 to engage in distributed or remote computing. For example, communication interface 422 may receive instructions from a remote device or send instructions to a remote device for execution.

In some examples, system memory 416 may store and/or load a network communication program 438 for execution by processor 414. In one example, network communication program 438 may include and/or represent software that enables computing system 410 to establish a network connection 442 with another computing system (not illustrated in FIG. 4) and/or communicate with the other computing system by way of communication interface 422. In this example, network communication program 438 may direct the flow of outgoing traffic that is sent to the other computing system via network connection 442. Additionally or alternatively, network communication program 438 may direct the processing of incoming traffic that is received from the other computing system via network connection 442 in connection with processor 414.

Although not illustrated in this way in FIG. 4, network communication program 438 may alternatively be stored and/or loaded in communication interface 422. For example, network communication program 438 may include and/or represent at least a portion of software and/or firmware that is executed by a processor and/or Application Specific Integrated Circuit (ASIC) incorporated in communication interface 422.

As illustrated in FIG. 4, example computing system 410 may also include a primary storage device 432 and a backup storage device 433 coupled to communication infrastructure 412 via a storage interface 434. Storage devices 432 and 433 generally represent any type or form of storage device or medium capable of storing data and/or other computer-readable instructions. For example, storage devices 432 and 433 may be a magnetic disk drive (e.g., a so-called hard drive), a solid state drive, a floppy disk drive, a magnetic tape drive, an optical disk drive, a flash drive, or the like. Storage interface 434 generally represents any type or form of interface or device for transferring data between storage devices 432 and 433 and other components of computing system 410. In one example, data elements 120 from FIG. 1 may be stored and/or loaded in primary storage device 432.

In certain embodiments, storage devices 432 and 433 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 432 and 433 may also include other similar structures or devices for allowing computer software, data, or other computer-readable instructions to be loaded into computing system 410. For example, storage devices 432 and 433 may be configured to read and write software, data, or other computer-readable information. Storage devices 432 and 433 may also be a part of computing system 410 or may be a separate device accessed through other interface systems.

Many other devices or subsystems may be connected to computing system 410. Conversely, all of the components and devices illustrated in FIG. 4 need not be present to practice the embodiments described and/or illustrated herein. The devices and subsystems referenced above may also be interconnected in different ways from that shown in FIG. 4. Computing system 410 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 410. All or a portion of the computer program stored on the computer-readable medium may then be stored in system memory 416 and/or various portions of storage devices 432 and 433. When executed by processor 414, a computer program loaded into computing system 410 may cause processor 414 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 410 may be configured as an Application Specific Integrated Circuit (ASIC) adapted to implement one or more of the example embodiments disclosed herein.

FIG. 5 is a block diagram of an example network architecture 500 in which client systems 510, 520, and 530 and servers 540 and 545 may be coupled to a network 550. As detailed above, all or a portion of network architecture 500 may perform and/or be a means for performing, either alone or in combination with other elements, one or more of the steps disclosed herein (such as one or more of the steps illustrated in FIG. 3). All or a portion of network architecture 500 may also be used to perform and/or be a means for performing other steps and features set forth in the instant disclosure.

Client systems 510, 520, and 530 generally represent any type or form of computing device or system, such as example computing system 410 in FIG. 4. Similarly, servers 540 and 545 generally represent computing devices or systems, such as application servers or database servers, configured to provide various database services and/or run certain software applications. Network 550 generally represents any telecommunication or computer network including, for example, an intranet, a WAN, a LAN, a PAN, or the Internet. In one example, client systems 510, 520, and/or 530 and/or servers 540 and/or 545 may include all or a portion of system 100 from FIG. 1.

As illustrated in FIG. 5, one or more storage devices 560(1)-(N) may be directly attached to server 540. Similarly, one or more storage devices 570(1)-(N) may be directly attached to server 545. Storage devices 560(1)-(N) and storage devices 570(1)-(N) generally represent any type or form of storage device or medium capable of storing data and/or other computer-readable instructions. In certain embodiments, storage devices 560(1)-(N) and storage devices 570(1)-(N) may represent Network-Attached Storage (NAS) devices configured to communicate with servers 540 and 545 using various protocols, such as Network File System (NFS), Server Message Block (SMB), Common Internet File System (CIFS), API-based Object Stores, etc.

Servers 540 and 545 may also be connected to a Storage Area Network (SAN) fabric 580. SAN fabric 580 generally represents any type or form of computer network or architecture capable of facilitating communication between a plurality of storage devices. SAN fabric 580 may facilitate communication between servers 540 and 545 and a plurality of storage devices 590(1)-(N) and/or an intelligent storage array 595. SAN fabric 580 may also facilitate, via network 550 and servers 540 and 545, communication between client systems 510, 520, and 530 and storage devices 590(1)-(N) and/or intelligent storage array 595 in such a manner that devices 590(1)-(N) and array 595 appear as locally attached devices to client systems 510, 520, and 530. As with storage devices 560(1)-(N) and storage devices 570(1)-(N), storage devices 590(1)-(N) and intelligent storage array 595 generally represent any type or form of storage device or medium capable of storing data and/or other computer-readable instructions.

In certain embodiments, and with reference to example computing system 410 of FIG. 4, a communication interface, such as communication interface 422 in FIG. 4, may be used to provide connectivity between each client system 510, 520, and 530 and network 550. Client systems 510, 520, and 530 may be able to access information on server 540 or 545 using, for example, a web browser or other client software. Such software may allow client systems 510, 520, and 530 to access data hosted by server 540, server 545, storage devices 560(1)-(N), storage devices 570(1)-(N), storage devices 590(1)-(N), or intelligent storage array 595. Although FIG. 5 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 540, server 545, storage devices 560(1)-(N), storage devices 570(1)-(N), storage devices 590(1)-(N), intelligent storage array 595, or any combination thereof. All or a portion of one or more of the example embodiments disclosed herein may also be encoded as a computer program, stored in server 540, run by server 545, and distributed to client systems 510, 520, and 530 over network 550.

As detailed above, computing system 410 and/or one or more components of network architecture 500 may perform and/or be a means for performing, either alone or in combination with other elements, one or more steps of an example method for incentivizing sharing of transaction information.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive transaction data to be transformed, transform the transaction data, output a result of the transformation to inform a user, use the result of the transformation to provide analysis, and store the result of the transformation to aggregate data with future transaction data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for incentivizing sharing of transaction information, at least a portion of the method being performed by a computing device comprising at least one processor, the method comprising:
receiving transaction data of a transaction between a user and a merchant, wherein a portion of a transaction amount is reserved;
receiving the reserved portion for adding to a fund;
aggregating the transaction data with collected transaction data from a plurality of users; and
providing the aggregated transaction data.

2. The method of claim 1, further comprising associating the reserved portion with the user.

3. The method of claim 2, further comprising calculating a dividend of the fund to distribute to the user based on the reserved portion.

4. The method of claim 3, further comprising distributing the dividend to the user in response to a trigger condition.

5. The method of claim 1, wherein aggregating the transaction data occurs periodically.

6. The method of claim 1, wherein aggregating the transaction data occurs in response to a trigger condition.

7. The method of claim 1, further comprising:
identifying at least one transaction characteristic from the aggregated transaction data; and
analyzing the aggregated transaction data for the at least one transaction characteristic.

8. The method of claim 7, further comprising providing results of the analysis.

9. The method of claim 7, wherein the analysis comprises statistical analysis for the at least one transaction characteristic.

10. The method of claim 7, wherein the analysis comprises predictive analysis for the at least one transaction characteristic.

11. The method of claim 7, wherein the at least one transaction characteristic comprises at least one of a merchant characteristic, an anonymized user characteristic, the transaction amount, a transaction timestamp, a transaction product, or a transaction mechanism.

12. The method of claim 1, wherein aggregating the transaction data with collected transaction data further comprises recording the aggregated transaction data on a distributed ledger.

13. A system for incentivizing sharing of transaction information, the system comprising:
a transaction module, stored in memory, configured to receive transaction data of a transaction between a user and a merchant, wherein a portion of a transaction amount is reserved;
a fund module, stored in memory, configured to receive the reserved portion for adding to a fund;
an analysis module, stored in memory, configured to aggregate the transaction data with collected transaction data from a plurality of users;
a data module, stored in memory, configured to provide the aggregated transaction data; and
at least one physical processor that executes the transaction module, the fund module, the analysis module, and the data module.

14. The system of claim 13, wherein the fund module is further configured to:
associate the reserved portion with the user;
calculate a dividend of the fund to distribute to the user based on the reserved portion; and
distribute the dividend to the user on a periodic basis.

15. The system of claim 13, wherein:
the analysis module is further configured to:
identify at least one transaction characteristic from the aggregated transaction data, wherein the at least one transaction characteristic comprises at least one of a merchant characteristic, an anonymized user characteristic, the transaction amount, a transaction timestamp, or a transaction product; and
analyze the aggregated transaction data for the at least one transaction characteristic; and
the data module is further configured to:
provide results of the analysis.

16. A non-transitory computer-readable medium comprising one or more computer-executable instructions that, when executed by at least one processor of a computing device, cause the computing device to:
receive transaction data of a transaction between a user and a merchant, wherein a portion of a transaction amount is reserved;
receive the reserved portion for adding to a fund;
aggregate the transaction data with collected transaction data from a plurality of users; and
provide the aggregated transaction data.

17. The non-transitory computer-readable medium of claim 16, further comprising instructions for:
associating the reserved portion with the user;
calculating a dividend of the fund to distribute to the user based on the reserved portion; and
distributing the dividend to the user on a periodic basis.

18. The non-transitory computer-readable medium of claim 16, further comprising instructions for:
identifying at least one transaction characteristic from the aggregated transaction data, wherein the at least one transaction characteristic comprises at least one of a merchant characteristic, an anonymized user characteristic, the transaction amount, a transaction timestamp, a transaction product, or a transaction mechanism;
analyzing the aggregated transaction data for the at least one transaction characteristic; and
providing results of the analysis.

19. The non-transitory computer-readable medium of claim 18, wherein the analysis comprises statistical analysis for the at least one transaction characteristic.

20. The non-transitory computer-readable medium of claim 18, wherein the analysis comprises predictive analysis for the at least one transaction characteristic.
